(19) United States
(12) Patent Application Publication
(10) Pub. No.: US 2025/0001338 A1
(43) Pub. Date: Jan. 2, 2025

(54) MULTIPHASE SUPERHYDROPHOBIC SEPARATOR

(71) Applicant: IRPI LLC, Wilsonville, OR (US)

(72) Inventors: Ryan M. Jenson, Happy Valley, OR (US); Oleg Krishcko, Vancouver, WA (US); Logan Torres, Hillsboro, OR (US); Mark Weislogel, Newberg, OR (US)

(21) Appl. No.: 18/755,412

(22) Filed: Jun. 26, 2024

Related U.S. Application Data
(60) Provisional application No. 63/511,095, filed on Jun. 29, 2023.

(51) Int. Cl. B01D 36/00; B01D 29/39

(52) U.S. Cl. CPC B01D 36/003; B01D 29/39; B01D 2239/1291

(57) ABSTRACT

Methods and systems are provided for a multiphase separating device comprising a superhydrophobic filter composed of at least one passage from an inlet of the multiphase separating device to a second outlet of the multiphase separating device, with a first outlet approximately midway between the inlet and the second outlet and perpendicular thereto. The superhydrophobic filter is formed of a plurality of superhydrophobic disks which are superhydrophobic on both a first face and a second face such that capillary non-wetting (e.g., gas-wicking) forces are established when the plurality of superhydrophobic disks are stacked in face-sharing contact. In one example, the at least one passage is formed as helical through holes configured to generate centrifugal separating forces.

### CROSS REFERENCE TO RELATED APPLICATIONS

The present application claims priority to U.S. Provisional Application No. 63/511,095, entitled “MULTIPHASE SUPERHYDROPHOBIC SEPARATOR”, and filed on Jun. 29, 2023. The entire contents of the above-listed application are hereby incorporated by reference for all purposes.

### FIELD

The present description relates generally to liquid, gas, and/or solid phase separating filters.

### BACKGROUND/SUMMARY

Numerous challenges are faced by the designers of life support systems for spacecraft because of the persistently unfamiliar and unforgiving low-gravity (low-g) environment. A common challenge is the collection (filtration) of gas from liquid streams. In low-g environments, gravity may not be leveraged to create buoyancy forces that passively separate fluids (e.g., liquids and gases) of different densities. Liquid-gas separations of mists, sprays, bubbly flows, and so on are pervasive and desired in numerous engineering systems. Example systems include: liquid-gas sorbent chemistry; filtration; heating, ventilation, and air conditioning (HVAC); demisters; firefighting equipment; and so on. Such systems are often directly tied to life support systems such as oxygen supply, air revitalization, thermal management systems, water reclamation, medical fluids, and so on. Prior solutions that provide liquid-gas separation in low-g environments include active separators and fine filters, both of which possess shortcomings of complexity and pressure drop. Active separators involve moving parts, which are disadvantageous due to added potential points of degradation that reduce reliability while increasing mass, power consumption, and noise. Fine filters also involve significant drawbacks that include high pressure drops due to the tortuous and low open area of such filters, as well as increasing pressure drop as saturation increases. Therefore, a low pressure drop liquid-gas phase separation device capable of largely passive liquid and gas bubble separation and collection is desired.

In order to at least partially address the issues described above, a multiphase separator described herein employs a superhydrophobic passage that exploits bubble points and wetting conditions for liquid-gas separating fluid flows. For example, gas bubbles are driven to walls of the passage where they adhere and are wicked inward (e.g., into the walls of the passage) and thus collected in the superhydrophobic material. The passage diameter is larger than a pore diameter of the superhydrophobic material. Thus, the superhydrophobic material may not be penetrated by liquid from which gas bubbles are wicked. The capillary non-wetting, gas-wicking force leads to the uniform passive migration of gas throughout the media for storage, further processing, or purge. Liquid flows through the passage without being absorbed because the pressure gradient across the liquid-superhydrophobic porous media does not exceed the bubble point. In some examples, the superhydrophobic passage has a helical conduit geometry that exploits passively induced centrifugal (inertial) forces on liquid-gas laden airflows. For example, gas bubbles are driven inward to conduit surfaces of the superhydrophobic material by the centrifugal forces, where they adhere and are wicked inward and throughout the superhydrophobic media, and thus collected in the superhydrophobic material. The multiphase separator described herein exploits inertial, capillary, and wetting forces to quickly separate gas/vapor-laden liquid streams into single liquid and gas/vapor outlet flows in a short distance and with low pressure drop.

In one example, the multiphase separator comprises an inlet, a first outlet perpendicular to the inlet, a second outlet in linear alignment with the inlet and perpendicular to the first outlet, and a superhydrophobic filter formed of superhydrophobic material. The superhydrophobic filter comprises at least one passage extending through a length of the superhydrophobic filter along a central axis extending from a first end to a second end. The first end of the superhydrophobic filter is aligned with the inlet. The second end of the superhydrophobic filter is aligned with the second outlet. A diameter of the passage is greater than an effective pore diameter of the superhydrophobic material.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a perspective view of a multiphase separator.

FIG. 2 shows a cross-section schematic of the multiphase separator.

FIG. 3 shows an exploded view of the multiphase separator.

FIG. 4 shows an array of triple helix channel configurations in a perspective view.

FIG. 5 shows an example of a triple helix channel configuration.

FIG. 6 shows a cross-section schematic of a second example of the multiphase separator.

FIG. 7 shows a cross-section perspective view of the second example of the multiphase separator.

FIG. 8 shows a schematic of a multiphase system, including the multiphase separator.

FIG. 9 illustrates a high-level method for operating a multiphase system, such as the multiphase system of FIG. 8.

### DETAILED DESCRIPTION

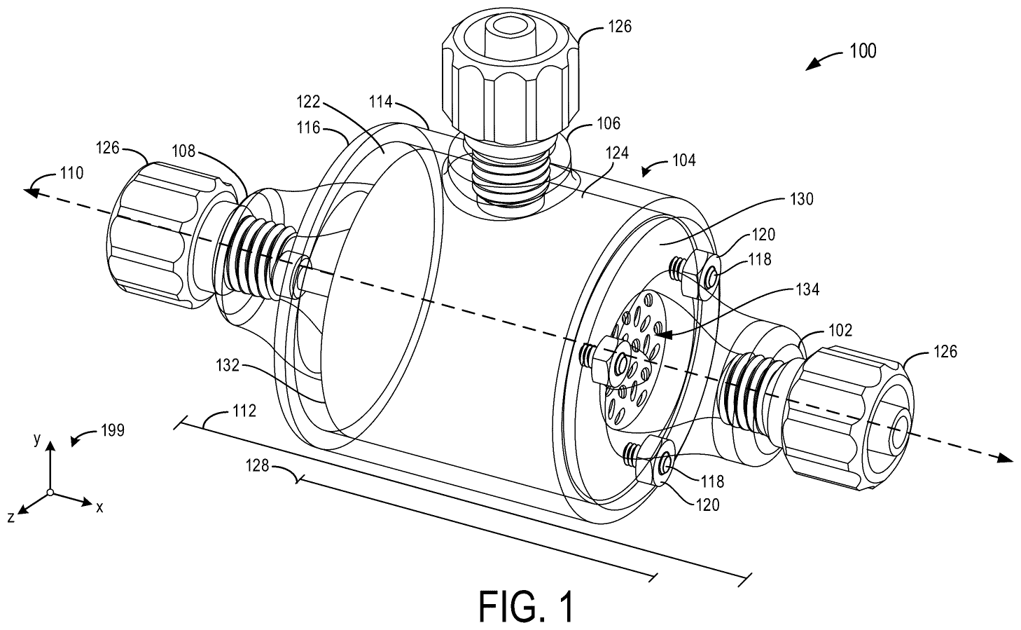

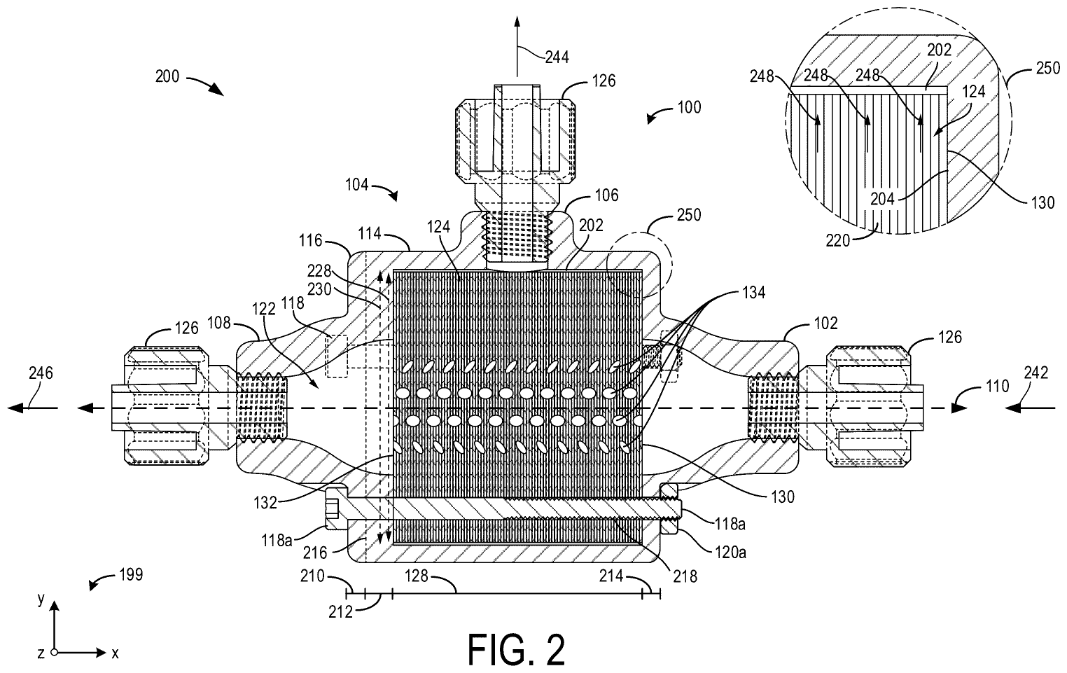

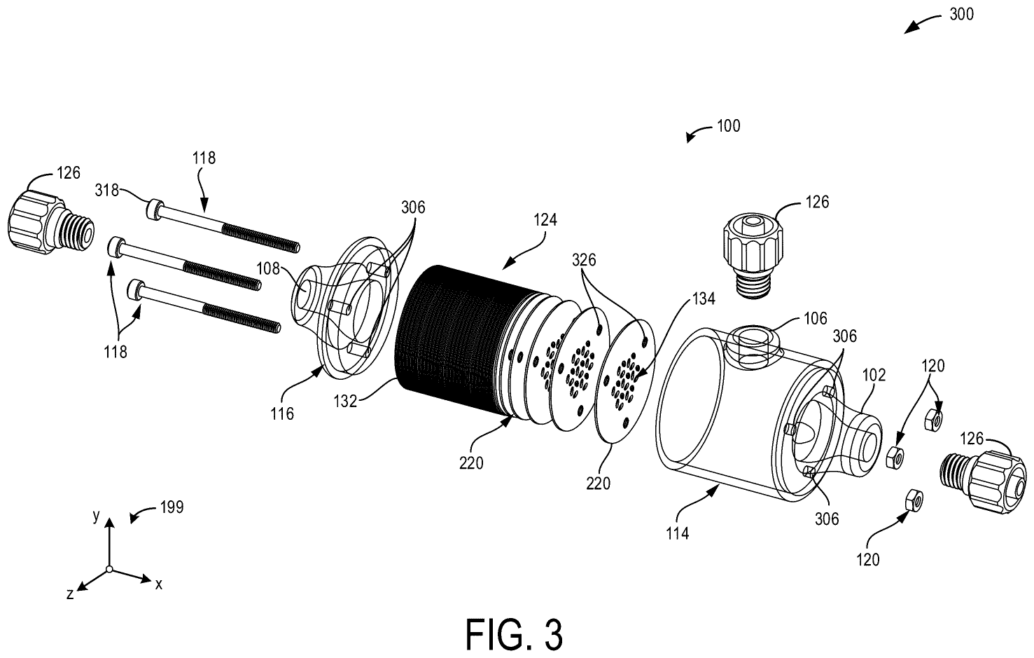

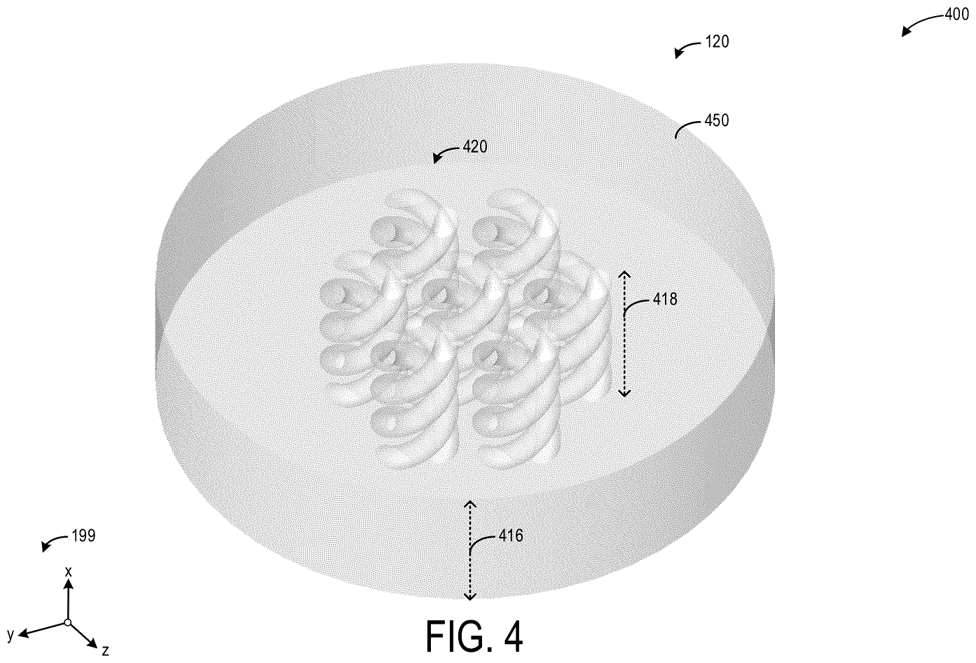

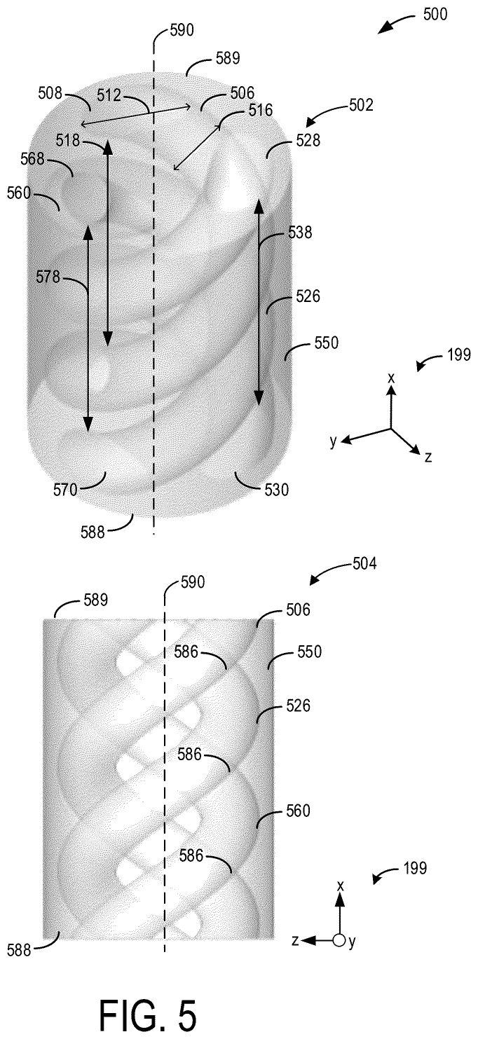

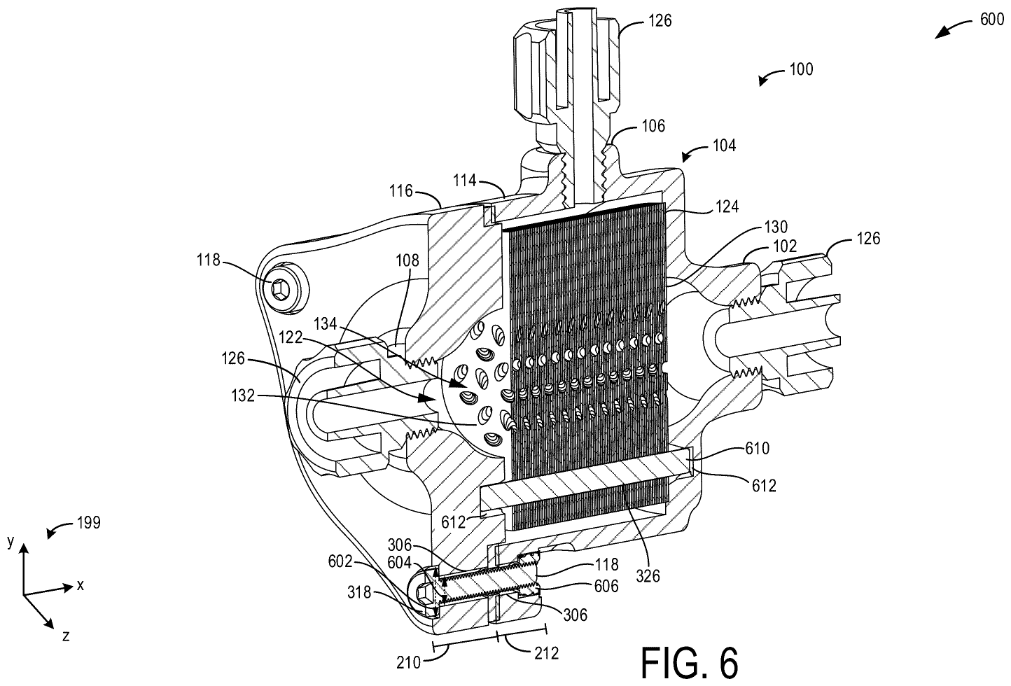

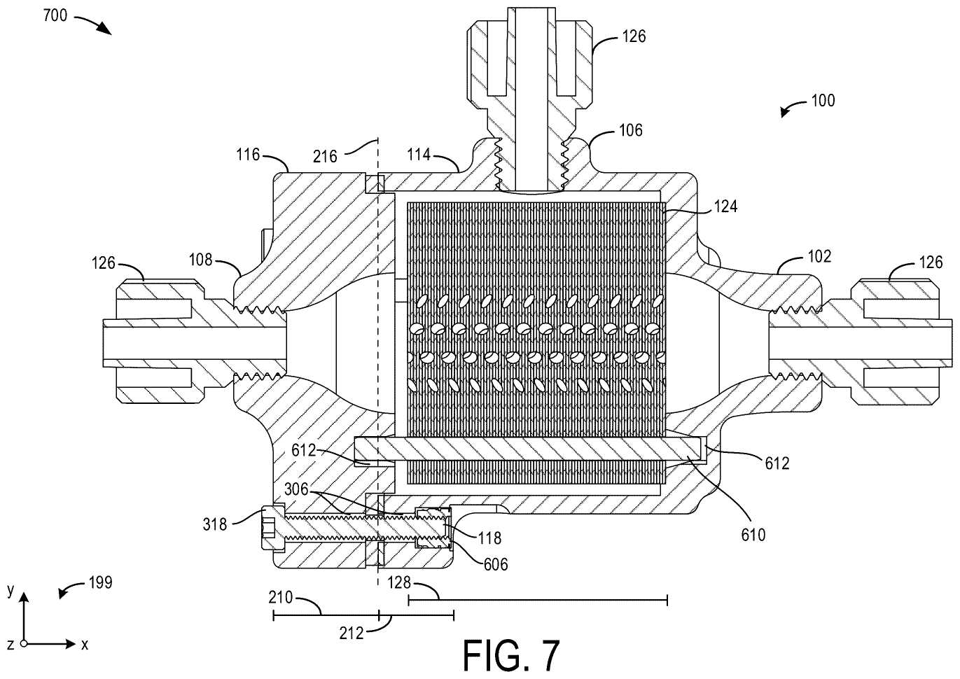

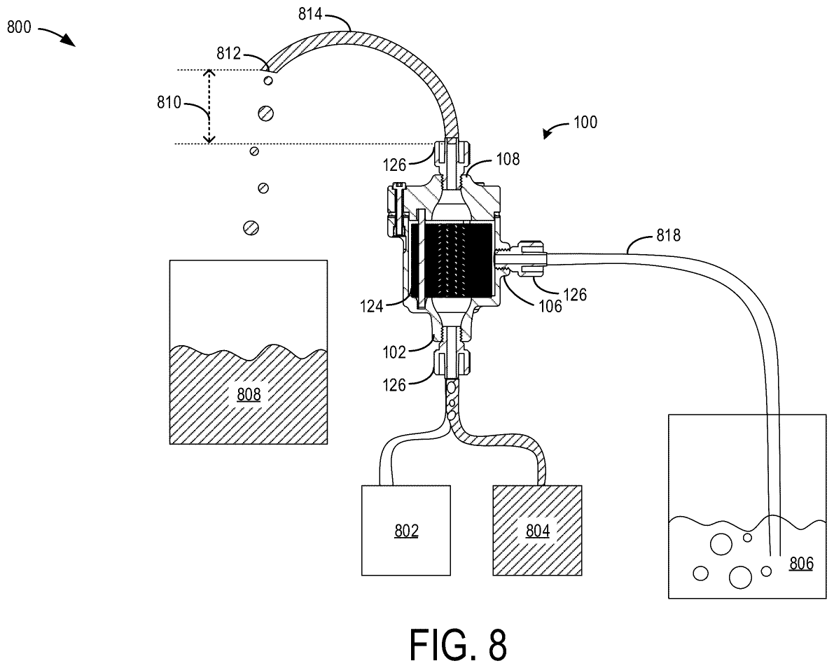

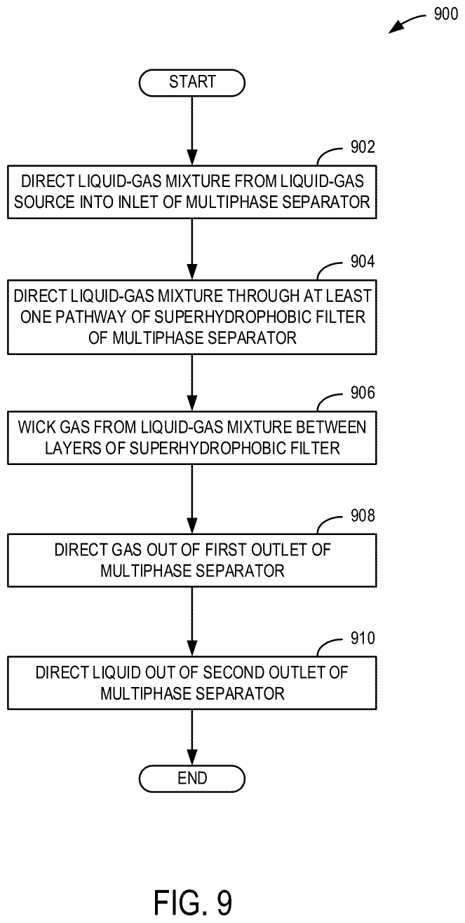

The following description relates to systems and methods for a multiphase gas/vapor-liquid separator, including a superhydrophobic filter. The multiphase separator may be included in a variety of applications for separating and collecting elements of a multiphase fluid (e.g., including a gas and a liquid). FIG. 1 shows a perspective view of the multiphase separator, where a housing of the multiphase separator is partially transparent to show a superhydrophobic filter positioned therein. FIG. 2 shows a cross-section schematic of the multiphase separator, including a stack of superhydrophobic material with at least one passage extending through the superhydrophobic filter. An exploded view of the multiphase separator is shown in FIG. 3. An example of the superhydrophobic filter of the multiphase separator is shown in FIG. 4, including a plurality of passages where each passage is configured as a triple helix. The triple helix configuration of FIG. 4 is further exemplified in FIG. 5. A second example configuration of the multiphase separator is shown in FIGS. 6 and 7, and includes at least one positioning pin that positions the superhydrophobic stack in the housing. The multiphase separator (e.g., of FIGS. 1-5 and/or 6-7) may be incorporated in a multiphase system and used to separate a two-phase flow of liquid and gas into single phase streams, as shown in FIG. 8. The multiphase system of FIG. 8 may be operated according to a method described with respect to FIG. 9. FIGS. 1-7 are shown approximately to scale and may be used to represent other relative dimensions without departing from the present disclosure.

FIG. 1 shows a perspective view of a first example of a multiphase separator 100. Reference axes 199 are included in FIGS. 1-7 in order to compare the views and relative orientations described below with the view of FIG. 1. Reference axes 199 includes three axes, namely an x-axis, a y-axis, and a z-axis. A positive direction for each axis is indicated by an arrow and/or by a filled circle. An open circle indicates a negative direction of an axis. The housing 104 is illustrated as transparent in FIG. 1 for visualization of internal elements of the multiphase separator 100. The multiphase separator 100 comprises a housing 104 having an inlet 102, a first outlet 106 that is perpendicular to the inlet 102, and a second outlet 108 that is in linear alignment with the inlet 102 and is perpendicular to the first outlet 106. The inlet 102 and the second outlet 108 are aligned along a central axis 110 that is parallel to the x-axis of the reference axes 199. The first outlet 106 is positioned parallel to the y-axis of the reference axes 199. The first outlet 106 may be positioned at an approximate middle of a length 112 of the housing 104.

The housing 104 may be formed of two or more pieces that are selectively coupled to each other. For example, the housing 104 may be formed of a body 114 and a cap 116. In the example of FIG. 1, the body 114 includes the inlet 102 and the first outlet 106, and the cap 116 includes the second outlet 108. The inlet 102 may comprise a somewhat conical extension from the body 114 of the housing 104. Additionally, the first outlet 106 may comprise a cylindrical extension, extending perpendicular from the housing 104 (e.g., perpendicular to the central axis 150). The second outlet 108 may comprise a somewhat conical extension from the cap 116 of the housing 104. The body 114 and the cap 116 may be selectively coupled by one or more fastening devices. For example, one or more bolts 118 may be positioned in through holes of the body 114 and the cap 116, as further shown in FIGS. 2-3. The body 114 and the cap 116 may be coupled by threading a nut 120 onto each of the one or more bolts 118. The body 114 and the cap 116 may be held in face-sharing contact by the one or more bolts 118 with the nut 120 threaded thereon.

The housing 104 includes an internal cavity 122. In the example shown in FIG. 1, the internal cavity 122 has a hollow cylindrical shape. In other examples, the internal cavity 122 may have a hollow cube or hollow rectangular prism shape. The inlet 102, the first outlet 106, and the second outlet 108 fluidly couple the internal cavity 122 of the housing 104 to an environment external to the multiphase separator 100. In some examples, one or more of the inlet 102, the first outlet 106, and the second outlet 108 may be coupled to a connector 126. The connector 126 may be used to couple the respective inlet and/or outlet to a tube, hose, or other fluid (e.g., liquid or gas) transport vessel and/or storage vessel. The connector 126 may be removably coupled to the respective inlet and/or outlet by various coupling means, such as press-fitting, threading, quick-turn, and so on. The connector 126 may further be removably coupled to the transport and/or storage vessel by the same or different coupling method (e.g., press-fitting, threading, etc.). For example, the connector 126 may be threaded into to the housing 104 at each of the inlet 102, the first outlet 106, and the second outlet 108, as shown in FIG. 1.

A superhydrophobic filter 124 is positioned in the internal cavity 122 of the housing 104. The housing 104 annularly encloses the superhydrophobic filter 124. The one or more bolts 118 that are used to couple the body 114 and the cap 116 of the housing 104 may also be used to position the superhydrophobic filter 124 in the internal cavity 122 of the housing 104. The superhydrophobic filter 124 is formed of superhydrophobic material, such as superhydrophobic polytetrafluoroethylene (PTFE). The superhydrophobic material is configured to absorb and/or retain and/or transport gas, but generally not liquid. The superhydrophobic filter 124 has a same degree of superhydrophobicity throughout the superhydrophobic filter 124. The superhydrophobic filter 124 comprises at least one gas-wicking and liquid-rejecting passage 134. In some embodiments, the superhydrophobic filter 124 includes more than one passage 134. Each of the least one passage 134 extends through a length 128 of the superhydrophobic filter 124 from a first end 130 of the superhydrophobic filter 124 to a second end 132 of the superhydrophobic filter 124. The first end 130 of the superhydrophobic filter 124 is aligned with the inlet 102. The second end 132 of the superhydrophobic filter 124 is aligned with the second outlet 108. As further shown in FIG. 2, the first end 130 of the superhydrophobic filter 124 may be in face sharing contact with an inner face of the body 114 at the inlet 102. A multiphase fluid including a mixture of liquid and gas that flows into the multiphase separator 100 via the inlet 102 flows into the passage 134 of the superhydrophobic filter 124. A diameter of the passage 134 is greater than an effective pore diameter of the superhydrophobic material, which enables liquid to pass through the passage 134 without being absorbed by the superhydrophobic material. In this way, liquid may flow through the passage 134 and gas may be wicked through the superhydrophobic material and out of the superhydrophobic filter 124, as further described herein.

At least one of the passages 134 of the superhydrophobic filter 124 may have a helical configuration. For passages 134 with helical configurations, as a multiphase fluid including gas and liquid flows through the passages, inertia drives gas into inner walls of the helix (e.g., into the superhydrophobic material) while the superhydrophobic material keeps liquid from penetrating walls of the passages 134 (e.g., into the superhydrophobic material). Further detail regarding directing liquid and gas using inertia in passages configured as a helix is described with respect to FIGS. 2-5.

FIG. 2 illustrates a cross-sectioned schematic 200 of the multiphase separator 100. The multiphase separator 100 is sectioned in the y-x plane, with respect to the reference axes 199. The superhydrophobic filter 124 may be positioned in the internal cavity 122 of the housing 104 using the bolts 118 that couple the body 114 to the cap 116. For example, the superhydrophobic filter 124 may comprise through holes, shown in FIG. 3, that extend along the length 128 of the superhydrophobic filter 124. Each of the bolts 118 may pass through a through hole of the superhydrophobic filter 124. Each of the bolts 118 may further pass through a through hole of the cap 116 and the body 114 of the housing 104. For example, as shown in FIG. 2, a first bolt 118a extends through a first portion 210 of the cap 116, through a first portion 212 of the body 114, through a through hole 218 of the superhydrophobic filter 124, through a second portion 214 of the body 114, and partially protrudes out of the body 114. A first nut 120a is threaded onto the portion of the first bolt 118a that protrudes out of the body 114 and may be used to couple the cap 116 and the body 114 in face-sharing contact (e.g., at a first dashed line 216).

A diameter 228 of the superhydrophobic filter 124 may be less than an inner diameter 230 of the internal cavity 122 of the housing 104. A plenum 202 extends about a circumference of the superhydrophobic filter 124 between the superhydrophobic filter 124 and internal walls of the body 114. The plenum 202 is shown in further detail in a view 250 of FIG. 2. In this way, the entirety of the superhydrophobic filter 124 may be in fluidic connection with the first outlet 106 in a radial direction. The first end 130 of the superhydrophobic filter 124 may be in face sharing contact with a face 204 of the body 114 at the inlet 102. Thus, there may not be a gap and/or space between the superhydrophobic filter 124 and the body 114 at the first end 130 of the superhydrophobic filter 124, along the x-axis.

The superhydrophobic filter 124 may be configured as a stack of a plurality of planar superhydrophobic disks that are in face-sharing contact with each other. A superhydrophobic disk 220 of the plurality of planar superhydrophobic disks is superhydrophobic on both a first face and a second face of a respective superhydrophobic disk. Each superhydrophobic disk 220 is configured with a plurality of passage holes arranged around an approximate center of the superhydrophobic disk 220. Each of the one or more passage holes extend through a thickness of the respective disk (e.g., where the thickness of the disk is parallel to the x-axis as shown in FIG. 2). Each superhydrophobic disk 220 may have the same or a different number of passage holes. The passage holes may be the same size and/or may have different sizes and/or shapes among the plurality of passage holes of a single superhydrophobic disk 220 and/or among superhydrophobic disks 220. An example of the plurality of passage holes of a superhydrophobic disk 220 is shown in FIG. 3. When a plurality of superhydrophobic disks are aligned to form the superhydrophobic filter 124, as shown in FIG. 2, at least one passage 134 is formed. For example, passage holes of a first superhydrophobic disk may at least partially align with passage holes of a second superhydrophobic disk that is in face-sharing contact with the first superhydrophobic disk. The cap 116 and the body 114 of the housing 104, via tightening of the nuts 120 on the bolts 118, may compress the stack of superhydrophobic disks. When the stack of superhydrophobic disks are compressed together to form the superhydrophobic filter 124, the one or more passage holes at least partially align to form the at least one passage 134. An efficiency of a capillary seal between layers of the superhydrophobic filter 124 may be increased by reducing space between layers (e.g., via compression). Each of the at least one passages 134 extends through the length 128 of the superhydrophobic filter 124 from the first end 130 to the second end 132 of the superhydrophobic filter 124. Further detail regarding configuration of the at least one passage 134 is described with respect to FIGS. 4-5.

In other embodiments of the multiphase separator 100, the superhydrophobic filter 124 may be formed without stacking materials. For example, the superhydrophobic filter 124 may be monolithic, monolithic/porous and coated with superhydrophobic material to make the filter superhydrophobic, or formed of another superhydrophobic material. A monolithic superhydrophobic filter 124 still comprises at least one passage that extends through the length 128 of the superhydrophobic filter 124, and is configured to wick gas from the at least one passage and direct liquid through the at least one passage for the length 128 of the superhydrophobic filter 124.

In some examples of the multiphase separator 100, the at least one passage 134 of the superhydrophobic filter 124 is configured as a substantially linear passage extending from an entrance hole at the first end 130 to an exit hole at the second end 132. The diameter of the entrance hole, the exit hole, and the passage 134 extending therebetween is greater than an effective pore diameter of the superhydrophobic material of the layers (e.g., superhydrophobic disks 220) of the superhydrophobic filter 124.

In the example described herein, the at least one passage 134 of the superhydrophobic filter 124 is configured as a plurality of helical through-channels formed by passage holes of the plurality of superhydrophobic disks 220. Dimensions (e.g., length, width, diameter, etc.) of the plurality of helical through-channels are larger than dimensions of pores of the superhydrophobic material (e.g., PTFE). As a result, the superhydrophobic filter 124 exploits inertial, capillary, and wetting forces to separate the gas and liquid entering the superhydrophobic filter 124. Additionally, a sum of cross-sectional areas of the passages is greater than a cross-sectional area of the inlet 102, which may reduce a pressure drop across the multiphase separator 100. The superhydrophobic filter 124 may be used to perform liquid-gas phase separations for bubbles of a wide range of length-scales including centimeter to micrometer sizes. The superhydrophobic filter 124 additionally contains no moving parts, low pressure losses, a constant pressure drop, and no additional power consumption due to its passive separation method utilizing motive fluid streams. This may increase a reliability of the superhydrophobic filter 124.

A multiphase fluid, such as liquid-gas mixture (e.g., a liquid-gas fluid flow), may enter the multiphase separator 100 via the inlet 102, as indicated by a first arrow 242. For example, the multiphase separator 100 may be removably coupled to a multiphase fluid source via the connector 126 at the inlet 102. The multiphase fluid may be a mixture of gas and liquid of a variety of flow rates and flow rate ratios. For example, the multiphase fluid flow may be driven externally by a blower, fan, buoyancy, gravity, etc., or be produced by outgassing, off-gassing, degassing, or chemical reaction. The multiphase fluid flow may enter the superhydrophobic filter 124 via the one or more passages 134. The superhydrophobic filter 124 may be in face-sharing contact with the housing 104 at the first end 130, such that the multiphase fluid flows into the at least one passage 134 and does not flow along a planar surface of the superhydrophobic filter 124, the planar surface parallel with the y-axis as shown in FIG. 1. In the example of FIGS. 1-2, the at least one passage 134 is configured as a plurality of helical through-channels, such as a triple helix. In other examples, the plurality of helical through-channels may be configured as single or double helices. Centrifugal accelerations drive the liquid of the liquid-gas mixture to the outer walls of the plurality of helical through-channels where gas bubbles may impinge onto the superhydrophobic material. The superhydrophobic material wicks and may retain the gas bubbles from the liquid-gas mixture. For example, the gas bubbles may spread and distribute within the superhydrophobic material by capillary forces, directing the gas bubbles away from the plurality of helical through-channels, which remain open to the liquid flow. A length and diameter of the plurality of helical through-channels include a margin for developing flows, local recirculation, droplet rolling, and satellite droplet rebound. The length, diameter, and number of helical channels is selected to remain below pressure drop specifications. Gas is wicked through layers of the stack radially from all sides and enters the plenum 202. A set of arrows 248 illustrates a directional flow of gas that is wicked through the superhydrophobic material of the superhydrophobic filter 124 and into the plenum 202. Gas in the plenum 202 exits the multiphase separator via the first outlet 106, as shown by a second arrow 244. The gas that exits may be free from liquid droplets and/or particles. Liquid may flow in the at least one passage along the central axis 110 in three-dimensional space (e.g., in the y-z plane, the y-x plane, and the z-x plane) without leaving the passage 134 (e.g., without being absorbed into the superhydrophobic material). For example, liquid does not penetrate into walls of the superhydrophobic filter 124 due to (non-) wetting conditions of the superhydrophobic filter 124. Liquid exits the multiphase separator 100 via the second outlet 108, as shown by a third arrow 246. The liquid that exits may be free from gas bubbles and/or particles.

FIG. 3 shows component parts of the multiphase separator 100 in an exploded view 300. Some component parts of the multiphase separator 100 that are described with respect to FIGS. 1-2 are labeled in FIG. 3 but are not reintroduced, for brevity.

Each of the body 114 and the cap 116 may include features for removably coupling the body 114 and the cap 116. For example, the body 114 and the cap 116 each have a plurality of fastening holes 306. Fastening holes 306 of the body 114 extend through the first portion 212 and the second portion 214 of the body 114, as shown in FIG. 2. Fastening holes 306 of the cap 116 extend through the first portion 210 of the cap 116, as shown in FIG. 2. The fastening holes 306 of each of the cap 116 and the body 114 may be linearly aligned when coupling the cap 116 and the body 114. The bolts 118 include a head 318 at a first end of each bolt 118. When inserted into the fastening holes 306, the head 318 of the bolt 118 may abut an exterior of the cap 116 and hold the bolt 118 in place (e.g., prevented from passing completely through the fastening hole 306).

Each superhydrophobic disk 220 of the plurality of superhydrophobic disks that are stacked to form the superhydrophobic filter 124 include one or more through holes 326 that extend through the thickness of the respective disk. A number of through holes 326 in each superhydrophobic disk may be equal to the number of fastening holes 306 in the cap 116 and the body 114. The through holes 326 may be positioned in the same position in each superhydrophobic disk. The through holes 326 of each superhydrophobic disk may be aligned with each other and with fastening holes 306 of the cap 116 and the body 114. The bolts 118 may be inserted into the fastening holes 306 and the through holes 326 to position the superhydrophobic filter 124 in the body 114 and to form the housing 104 of the multiphase separator 100.

Each superhydrophobic disk 220 may be thin, such as 0.01 inch along the x-axis, with respect to the reference axes 199. In some examples, at least 90 superhydrophobic disks 220 may be stacked to form the superhydrophobic filter 124. In other examples, the superhydrophobic disk 220 may be formed of another superhydrophobic material and/or have a different thickness, and the same or a different number of superhydrophobic disks may be layered to form the stack. The superhydrophobic disk 220 may have a contact angle of greater than 150 degrees, and be non-perforated. Layering the superhydrophobic disks 220 may include stacking a plurality of superhydrophobic disks 220 in alignment along a central axis such that each face of all but a top superhydrophobic disk 220 (e.g., at the first end 130) and a bottom superhydrophobic disk 220 (e.g., at the second end 132) are in face-sharing contact with an adjacent superhydrophobic disk. Each of the superhydrophobic disks 220 are superhydrophobic on both faces of the superhydrophobic disk 220. A capillary seal may be formed between each superhydrophobic disk 220 when stacked in face-sharing contact, which may prevent liquid from penetrating and/or flowing between layers (e.g. superhydrophobic disks 220) of the superhydrophobic filter 124.

FIG. 4 shows a perspective view 400 of an example of the superhydrophobic filter 124 of the multiphase separator 100. The at least one passage 134 of the superhydrophobic filter 124 shown in FIG. 4 is configured as plurality of helical passage units 420. The helical passage units 420 are shown here within a superhydrophobic material 450 (e.g., PTFE) and are examples of a triple helix configuration 500 shown in FIG. 5, as further discussed below. In other examples, the helical passage units 420 may be a single helix configuration, a double helix configuration, or a mixture of two or more of the helix configurations. The helical passage units 420 are shown in an array with one row having three helical passage units 420 between two rows with two helical passage units 420 each (e.g., seven sets of triple helical configurations). Within the superhydrophobic filter 124, there may be more or fewer helical passage units. For example, the superhydrophobic filter 124 may include an amount of rows between 1 to 5, 5 to 10, 15 to 20, 20 to 50, or more. The helical passage units may be arranged in an array with equal dimensions within the superhydrophobic filter 124 to form a square filter or may have unequal dimensions to form a rectangular filter or a circular filter, as shown herein. In other examples, the helical passage units 420 may be arranged in a circle, spiral, or oblong shape to fit packaging desires for the superhydrophobic filter 124. The number of helical passage units 420 within a superhydrophobic filter 124 may depend on the amount of rows and the helical configuration (e.g., packing density) of the helical passage units 420. Additionally, the helical passage units 420 may be interwoven or overlapped in tighter arrays to increase media porosity. As a further example, the helical passage units 420 may alternate between right or left handed thread for net flow uniformity.

In the example of FIG. 4, the helical channels may all have an equal pitch. In other examples, the helical channels may have unequal pitches. A height 418 may be equal for all the helical channels. As another example, the height 418 may increase with a smaller pitch or decrease with a larger pitch. The height 418 may be equal to the length/thickness 416 of the stack of superhydrophobic disks (e.g., the height 418 may extend an entire length/thickness 416 of the superhydrophobic filter 124). Helical passages enhance adhesion of bubbles with the superhydrophobic material, but may not be essential to gas/vapor-liquid separation by the multiphase separator 100. Depending on the gas/vapor-liquid flow rates and flow rate ratios, straight passages may function adequately to separate a gas/vapor and liquid flow.

Turning now to FIG. 5, a triple helix configuration 500 comprising three helical passages is shown in a perspective view 502 and in a side view 504. For example, the triple helix configuration 500 may be implemented within the superhydrophobic filter 124 shown in FIGS. 1-4. As a further example, the triple helix configuration 500 may be used in the superhydrophobic filter 124 in combination with a single helix configuration and/or a double helix configuration. For example, there may be alternating rows of the single helix configuration, the double helix configuration, and/or the triple helix configuration. As another example, the single helix configuration, the double helix configuration, and/or the triple helix configuration 500 may alternate one after the other. Additionally, the triple helix configuration 500 may be preferred over the double helix configuration and the single helix configuration where increased flow per volume instead of additional porous material to hold filtered liquids and/or gases is desired.

The triple helix configuration 500 includes a first helical passage 506 with a first entrance hole 508, a first exit hole (not shown), and first pitch 518. The triple helix configuration 500 additionally includes a second helical passage 526 with a second entrance hole 528, a second exit hole 530, and a second pitch 538. Furthermore, a third helical passage 560 with a third entrance hole 568, a third exit hole 570, and a third pitch 578 is included within the triple helix configuration 500. The first helical passage 506, second helical passage 526, and third helical passage 560 are shown twisting around a central axis 590, which is shown on the side view 504 and is parallel to the x-axis. As shown in the triple helix configuration 500, the first helical passage 506, the second helical passage 526, and third helical passage 560 may maintain an equal radial distance away from the central axis 590. In other examples, the first helical passage 506, the second helical passage 526, or the third helical passage 560 may fluctuate a radial distance away from the central axis 590 (e.g., a distance from the central axis parallel to a z-y plane of the reference axes 199). For example, the radial distance for each turn may be different, or, as another example, the radial distance may be similar for some turns and different for others. As a further example, the radial distance may alternate between two or more different radii. Additionally, the first helical passage 506, second helical passage 526, and third helical passage 560 are shown completing one and a half rotations where a rotation is a 360 degree turn, however, any number of rotations may be used. For example, 1, 2, 3, or more rotations may be completed, and the rotations may be complete or partial (e.g., 0.25, 0.50, 0.75, etc.).

Furthermore, the first helical passage 506, the second helical passage 526, and the third helical passage 560 extend from a top surface 589 of the superhydrophobic material 550 to a bottom surface 588 of the superhydrophobic material 550. For example, the first entrance hole 508, the second entrance hole 528, and the third entrance hole 568 may be openings defined by a circular edge located on the top surface 589 and may not be obstructed with the superhydrophobic material 550. Similarly, the first exit hole, the second exit hole 530, and the third exit hole 570 may be defined by a circular edge located on the bottom surface 588 and may not be obstructed with the superhydrophobic material 550. The first helical passage 506, the second helical passage 526, and the third helical passage 560 includes internal walls 586. The internal walls 586 may be open to the superhydrophobic material 550 via the porosity of the superhydrophobic material 550. For example, the first helical passage 506, the second helical passage 526, and the third helical passage 560 are not passages formed by the general porosity of the superhydrophobic material 550.

A first entrance diameter 512 of the first entrance hole 508 may be equal to a first channel diameter 516 of the first helical passage 506 and equal to a first exit diameter of the first exit hole. As another example, the first channel diameter 516 may be smaller than the first entrance diameter 512 and the first exit diameter. A second entrance diameter of the second entrance hole may be equal to a second channel diameter of the second helical passage and/or equal to a second exit diameter of the second exit hole. As another example, the second channel diameter may be smaller than the second entrance diameter and the second exit diameter. A third entrance diameter of the third entrance hole may be equal to a third channel diameter of the third helical passage and/or equal to a third exit diameter of the third exit hole. As another example, the third channel diameter may be smaller than the third entrance diameter and the third exit diameter. As a further example, all, some or none of the third entrance diameter, the third channel diameter, and the third exit diameter, the first entrance diameter, first channel diameter, and first exit diameter, and the second entrance diameter, second channel diameter, and second exit diameter may be equal.

As an additional example, the first pitch 518, the second pitch 538, and the third pitch 578 may be equal such that the first helical passage 506, the second helical passage 526, and the third helical passage 560 do not intersect. In this way, flow through the superhydrophobic filter may be increased for a given packing density. In situations of low small volume items are desired (e.g., in a space station), the triple helix configuration 500 decreases an amount of linear space desired for filtering while increasing a flow through the superhydrophobic filter, which may increase an amount filtered for a given time period.

A combination of liquid and gases may enter the first helical passage 506 through the first entrance hole 508, enter the second helical passage 526 through the second entrance hole 528, and enter the third helical passage 560 through the third entrance hole 568. As the liquid and gases pass through the first helical passage 506, the second helical passage 526, and the third helical passage 560 the gases may impinge on and be absorbed by the superhydrophobic material 550. As such, gases may not exit through the first exit hole, the second exit hole 530, nor the third exit hole 570, leaving liquids to exit the first helical passage 506 through the first exit hole, exit the second helical passage 526 through the second exit hole 530, and exit the third helical passage 560 through the third exit hole 570.

FIGS. 6 and 7 illustrate a second example configuration of the multiphase separator 100. The second example configuration embodies some of the same configuration as the multiphase separator 100. Thus, one or more elements of the second example configuration may be labeled as is introduced with respect to FIGS. 1-5, and may not be reintroduced for brevity. Differences between the first example configuration of the multiphase separator 100 of FIGS. 1-5 and the second example configuration are described herein with respect to FIGS. 6 and 7.

FIG. 6 shows a cross-sectioned perspective view 600 of the second example configuration of the multiphase separator 100. The view 600 sections the multiphase separator 100 in the y-x plane, with respect to the reference axes 199. It is to be understood that the multiphase separator 100 is symmetric across the sectioning y-x plane.

In the example of FIG. 6, the cap 116 has a curved triangular shape. Bolts 118 are positioned at each point of the curved triangular shape. The first portion 212 of the body 114 (e.g., that is in face-sharing contact with the cap 116) may also have a curved triangular shape. The cap 116 is removably coupled to the body 114 via one or more bolts 118. The cap 116 and the body 114 each comprise fastening holes 306 that extend through a length of the cap 116 and the body 114 (e.g., through the first portion 210 of the cap 116 and through a first portion 212 of the body 114). In the example of FIG. 6, the first portion 210 of the cap 116 may be longer than the first portion 212 of the body 114. The first portion 212 of the body 114 comprises a fastening receiver 606 configured to receive the bolt 118 and couple the cap 116 to the body 114. For example, the fastening receiver 606 may include threading that is complementary to threading of the bolt 118. The bolt 118 may be inserted into the fastening hole 306 of the first portion 210 of the cap 116, inserted into the fastening hole 306 of the first portion 212 of the body 114, and be threaded into the fastening receiver 606 of the body 114. The head 318 of the bolt 118 may prevent the bolt 118 from being driven through the entirety of the first portion 210 of the cap 116. For example, the fastening hole 306 of the first portion 210 of the cap 116 may have a shape that is complementary to the shape of the bolt 118, and may include a first section with a first diameter 602 that is greater than a second diameter 604 of a second section.

In the example of FIG. 6, the bolts 118 are positioned away from the internal cavity 122 of the housing 104. Thus, the bolts 118 do not pass through the superhydrophobic filter 124 and may not be used to position the superhydrophobic filter 124 in the housing 104. Instead, the multiphase separator 100 of FIG. 6 comprises one or more positioning rods 610. The positioning rods 610 are configured to pass through the through holes 326 of the superhydrophobic disks of the superhydrophobic filter 124. The positioning rods 610 may be removably positioned in a recess 612 of the cap 116 and the body 114. In some examples, the positioning rod 610 may be fixedly coupled to the recess 612 of the cap 116 or the body 114.

FIG. 7 shows a side cross-sectioned view 700 of the second example configuration of the multiphase separator 100. The view 700 sections the multiphase separator 100 in the y-x plane, with respect to the reference axes 199. It is to be understood that the multiphase separator 100 is symmetric across the sectioning y-x plane. The first portion 212 of the body 114 through which the fastening hole 306 extends may overlap with, and be distanced away from, the internal cavity 122. For example, the fastening hole 306 of the body 114 in the first example configuration of FIGS. 1-3 is in line with the internal cavity 122 along the x-axis. In the second example configuration of FIGS. 6-7, the fastening hole 306 of the body 114 may be parallel to the internal cavity 122, and is spaced away from the internal cavity 122 along the y-axis. Thus, the first portion 212 of the body 114 overlaps with the length 128 of the superhydrophobic filter 124, and the bolt 118 does not extend into the superhydrophobic filter 124. As the internal cavity 122 is not fluidly coupled to the fastening holes 306 in the second example configuration of the multiphase separator 100, leakage of gas and/or liquid out of the internal cavity 122 and out of the multiphase separator 100 may be reduced, compared to the first example configuration of the multiphase separator 100.

By positioning the superhydrophobic filter 124 in the housing 104 using one or more positioning rods 610 instead of the bolts 118, the superhydrophobic filter 124 may be more easily replaced. For example, after repeated use of the superhydrophobic filter 124, particulate matter may build up in one or more of the passages 134, which may reduce a gas-wicking ability of the superhydrophobic filter 124. It may be desirable to remove the superhydrophobic filter 124 and replace with a superhydrophobic filter 124 that does not have built up particulate matter. In the first example multiphase separator 100 of FIGS. 1-3, removal of the superhydrophobic filter 124 may include unscrewing the bolt 118 and sliding the bolt 118 out of the through holes 326 of the superhydrophobic filter 124 and the fastening holes 306 of the body 114 and the cap 116. The cap 116 may be removed from the body 114. In this example, the superhydrophobic filter 124 may be resting against walls of the internal cavity 122 of the body 114, as the bolts 118 are not holding the superhydrophobic filter 124 in place with respect to the body 114. Further, when formed of a plurality of superhydrophobic disks 220, the superhydrophobic filter 124 may not be a compressed stack of superhydrophobic disks 220 and instead the superhydrophobic disks may each be positioned in the internal cavity 122 of the body 114 as individual pieces, which may make removal of all of the superhydrophobic disks time consuming and disorganized.

In the second example configuration of the multiphase separator 100 of FIGS. 6-7, the bolt 118 may be unscrewed from the fastening receiver 606 and may be removed from the cap 116 and the body 114 without changing the position of the superhydrophobic filter 124 in the internal cavity 122. The cap 116 and/or the body 114 may be separated from the respective other piece of the housing 104, and the superhydrophobic filter 124 may remain intact as a single, monolithic piece (e.g., a stack of superhydrophobic disks) positioned on the positioning rod 610. The superhydrophobic filter 124, and optionally the positioning rod 610, may be removed from the multiphase separator 100 and replaced with a non-degraded superhydrophobic filter 124.

Operation of the multiphase separator 100 to separate a multiphase fluid (e.g., liquid-gas mixture) into single phase flows is described with respect to FIG. 8. A multiphase separating system 800 illustrated in FIG. 8 is set in a normal gravity environment, such as a non-vacuum environment on Earth. The multiphase separator 100 may be removably coupled to inlet flow streams via luer fittings, such as the connector 126 of the inlet 102, or another sufficient removable coupling that is coupled to the inlet 102. For example, as shown in FIG. 8, a gas source 802 and a liquid source 804 may both be connected to the multiphase separator 100 at the connector 126 of the inlet 102. Liquid of the liquid source may be colored to enable visualization of the liquid and differentiation from another liquid used in the multiphase separating system 800, as further described herein. The two-phase fluid flow of liquid and gas may enter the multiphase separator 100 via the inlet 102 and from the inlet 102, flow into the at least one passage (e.g., helical passage) of the superhydrophobic filter 124. As described above, gas bubbles may be wicked through layers of the superhydrophobic filter 124 (e.g., into the superhydrophobic material of the superhydrophobic filter), out of the superhydrophobic filter 124 and into the plenum (e.g., the plenum 202 of FIG. 2), and out of the multiphase separator 100 via the first outlet 106. The connector 126 of the first outlet 106 is shown in the multiphase separating system 800 to be coupled to a gas tube 818 which directs gas flow out of the multiphase separator 100 into a liquid-filled container 806. Visualization of bubbles in the liquid of the liquid-filled container 806, as well as no change in color to the liquid, indicates that gas and liquid have been separated into single phase streams by the multiphase separator 100. Liquid may flow out of the second outlet 108 of the multiphase separator 100 and be deposited into a liquid container 808.

Pressure inside each of the at least one passage of the superhydrophobic filter 124 may be less than a bubble point pressure of the superhydrophobic stack to prevent liquid from leaking into the first outlet 106 (e.g., the gas outlet). Backpressure is provided upstream of the multiphase separator 100 to direct gas into the superhydrophobic layers of the superhydrophobic filter 124, thus preventing gas bubbles from passing through the entire length of the passage and out of the multiphase separator 100 at the second outlet 108. For example, a hydrostatic head 810 provided by a height different between the second outlet 108 and an outlet 812 of a liquid outlet tube 814 provides backpressure to the multiphase separator 100 shown in FIG. 8. In low or zero gravity environments, backpressure may be provided through other means, such as a check valve or other backpressure source. Configuration of the superhydrophobic filter 124 (e.g., number of superhydrophobic disks, shape/thickness/size of each layer, etc.) and configuration of the housing 104 (e.g., shape, size, etc.) may be adjusted (e.g., increased or decreased) to change a backpressure demand used to drive liquid through the passage, as well as change the pressure drop across the device. In this way, the multiphase separator may be adjusted based on flow conditions, such as amount of gravity.

The multiphase separating system 800 of FIG. 8 may separate liquid and gas of a liquid-gas mixture into single streams of liquid and gas (e.g., a liquid stream and a gas stream) according to a method for operating a multiphase system, with or without the aid of hydrostatic forces such as centrifugation or gravity. FIG. 9 illustrates an example method 900 for operating the multiphase system (e.g., the multiphase separating system 800). The method 900 may be used to operate any multiphase system comprising a multiphase separator (e.g., the multiphase separator 100) coupled to a liquid-gas mixture source at the inlet and having a backpressure source upstream of the multiphase separator. The method 900 is described herein with respect to FIG. 9.

At 902, the method 900 includes directing a liquid-gas mixture from a liquid-gas source into an inlet of a multiphase separator. For example, the liquid-gas source may be the gas source 802 and the liquid source 804 which are both connected to the multiphase separator 100 at the connector 126 of the inlet 102, or may be a single source containing the liquid-gas mixture, coupled to the inlet 102.

At 904, the method 900 includes directing the liquid-gas mixture through at least one passage of the superhydrophobic filter of the multiphase separator. As described herein with respect to FIGS. 1-8, the superhydrophobic filter may be formed of layered planar superhydrophobic material. An otherwise created superhydrophobic porous material will perform a similar role. A diameter of the passage is greater than an effective pore diameter of the superhydrophobic material, and the at least one passage extends through a length of the superhydrophobic filter from a first end to a second end, where the first end of the superhydrophobic filter is aligned with the inlet. In some examples, such as described with respect to FIGS. 4-5, the at least one passage may include more than one passage extending from the first end to the second end of the superhydrophobic filter, and one or more of the at least one passage may be configured as a helical passage.

At 906, the method 900 includes wicking gas bubbles from the liquid-gas mixture between layers of the superhydrophobic filter to separate gas from liquid of the liquid-gas mixture in the at least one passage, and, at 908, directing gas bubbles out of a first outlet of the multiphase separator, the first outlet perpendicular to the inlet. Additionally, at 910, the method 900 includes directing liquid out of a second outlet of the multiphase separator, the second outlet aligned with the second end, parallel to the inlet and perpendicular to the first outlet.

During operation of the multiphase system, backpressure may be provided to the multiphase separator by a backpressure source to direct gas into the superhydrophobic layers of the superhydrophobic filter and prevent gas bubbles from passing through the entire length of the passage and out of the multiphase separator. The method of operation may include adjusting an amount of backpressure provided to the multiphase separator by the backpressure source. For example, the amount of backpressure may be adjusted based on a volume of gas exiting the multiphase separator via the second outlet. The method may include decreasing the amount of backpressure provided by the backpressure source when a volume of gas is directed out of the second outlet of the multiphase separator. The volume of gas may be any volume of gas which is detectable, for example visually or by a detection instrument coupled to the second outlet of the multiphase separator. In other examples, the volume of gas may be a volume which is greater than an allowable threshold amount of gas, where the allowable threshold of gas is an amount above which instruments coupled to the second outlet of the multiphase separator may be degraded by the volume of gas.

In addition to liquid-gas separation, the multiphase separator 100 may be used to maintain phase separation during intermittent flow of a single phase, so long as downstream backpressure is maintained. For example, flowing gas through the multiphase separator may result in gas exiting through the first outlet and no gas exiting through the second outlet (e.g., the liquid outlet), even in the absence of liquid flow. Additionally, if a liquid is flowed through the multiphase separator 100, all liquid would exit through the second outlet and none through the first outlet (e.g., the gas outlet), even if the flow into the multiphase separator 100 is suddenly switched from liquid to gas, or vice-versa.

The multiphase separator described herein may provide passive phase separation of a multiphase fluid with low complexity, as no electrical or mechanical mechanisms, gravity, or centrifuge, etc. are used. The multiphase separator leverages wetting conditions and monolithic (e.g., non-coating) superhydrophobic surfaces to achieve high-efficiency phase separation.

The disclosure also provides support for a multiphase separation device, comprising a gas-wicking and liquid-rejecting corkscrew passage formed of a plurality of superhydrophobic disks stacked to form a superhydrophobic filter, wherein each disk is superhydrophobic on both faces and creates a capillary seal between disk layers when stacked. In a first example of the multiphase separation device, the superhydrophobic filter is comprised of a plurality of superhydrophobic disks positioned/held in place by a plurality of bolts which extend through the superhydrophobic disks. In a second example of the device, optionally including the first example, the superhydrophobic disk is formed of 0.1 in thick superhydrophobic PTFE with a plurality of passage holes. In a third example of the device, optionally including one or both of the first and second examples, tightening a nut on each of the bolts pulls a housing cap in a direction towards a first end and further compresses the stack of superhydrophobic disks, decreasing a space between each of the plurality of disks. In a fourth example of the system, optionally including one or more or each of the first through third examples, a housing diameter of the housing is greater than a disk stack diameter of the disk stack, such that a plenum is formed between the disk stack and the housing. In a fourth example of the system, optionally including one or more or each of the first through fourth examples, the housing further comprising a first outlet, a second outlet, and an inlet pipe, the inlet positioned on a first end of the housing, the second outlet positioned on the second end of the housing, and the first outlet positioned on a side of the housing, perpendicular to the first end and the second end. In a sixth example of the system, optionally including one or more or each of the first through fifth examples, a sum of cross-sectional areas of the corkscrew passages is greater than an inlet cross section of the inlet. In a seventh example of the system, optionally including one or more or each of the first through sixth examples, a pressure inside the corkscrews is less than a bubble point of the superhydrophobic filter. In an eighth example of the system, optionally including one or more or each of the first through seventh examples, back pressure is provided upstream of the device to direct bubble flow through the superhydrophobic filter. wherein downstream back pressure is provided using a check valve or, in conditions where gravity is present, a hydrostatic head.

In this way, a superhydrophobic filter including passages within a superhydrophobic material may perform liquid-gas phase separations for bubbles of a wide range of length-scales including centimeter to micrometer sizes. Furthermore, the superhydrophobic filter advantageously has no moving parts, low pressure losses, constant pressure drop, and no additional power consumption due to its passive separation method utilizing motive fluid streams, geometric flow components, and capillary non-wetting (gas-wicking) forces.

The disclosure also provides support for a multiphase separator, comprising: an inlet, a first outlet perpendicular to the inlet, a second outlet in linear alignment with the inlet and perpendicular to the first outlet, and a superhydrophobic filter formed of superhydrophobic material with at least one passage extending through a length of the superhydrophobic filter along a central axis extending from a first end to a second end, where the first end of the superhydrophobic filter is aligned with the inlet and the second end of the superhydrophobic filter is aligned with the second outlet, and a diameter of the passage is greater than an effective pore diameter of the superhydrophobic material. In a first example of the system, the at least one passage has a helical configuration. In a second example of the system, optionally including the first example, the at least one passage comprises three helical passages extending along the central axis from the first end surface to the second end of the superhydrophobic filter. In a third example of the system, optionally including one or both of the first and second examples, the at least one passage comprises at least one of overlapped helical passages, interwoven helical passages, right handed thread helical passages, or left handed thread helical passages. In a fourth example of the system, optionally including one or more or each of the first through third examples, the superhydrophobic material is configured as a plurality of layered planar superhydrophobic disks which are superhydrophobic on both a first face and a second face of a respective superhydrophobic disk. In a fifth example of the system, optionally including one or more or each of the first through fourth examples, the superhydrophobic filter has a same degree of superhydrophobicity throughout the superhydrophobic filter. In a sixth example of the system, optionally including one or more or each of the first through fifth examples, the superhydrophobic material is configured to absorb and/or retain and/or transport gas, but generally not liquid. In a seventh example of the system, optionally including one or more or each of the first through sixth examples, the system further comprises: a housing formed of a cap and a body, the cap removably coupled to the body via a plurality of bolts and a corresponding plurality of nuts, the body configured to have the superhydrophobic filter positioned therein. In an eighth example of the system, optionally including one or more or each of the first through seventh examples, a diameter of the superhydrophobic filter is less than an inner diameter of the housing of the multiphase separator, and a plenum is formed between the superhydrophobic filter and the housing. In a ninth example of the system, optionally including one or more or each of the first through eighth examples, the body includes the inlet and the first outlet and the cap includes the second outlet. In a tenth example of the system, optionally including one or more or each of the first through ninth examples, the superhydrophobic filter is in face sharing contact with the body of the housing at the first end.

The disclosure also provides support for a multiphase separation device, comprising: a gas-wicking and liquid-rejecting corkscrew passage formed of a plurality of superhydrophobic disks stacked to form a superhydrophobic filter, wherein each superhydrophobic disk is superhydrophobic on both faces and creates a capillary seal between superhydrophobic disk layers when stacked. In a first example of the system, the system further comprises: a housing which annularly encloses the superhydrophobic filter and has an inlet on a first end, a first outlet perpendicular to the inlet and positioned at an approximate middle of a length of the housing, and a second outlet in linear alignment with the inlet. In a second example of the system, optionally including the first example, the superhydrophobic filter is removably positioned in the housing by a plurality of bolts.

The disclosure also provides support for a method for operating a multiphase system, comprising: directing a liquid-gas mixture from a liquid-gas source into an inlet of a multiphase separator, directing the liquid-gas mixture through at least one passage of a superhydrophobic filter of the multiphase separator, wherein the superhydrophobic filter is formed of layered planar superhydrophobic material, a diameter of the passage is greater than an effective pore diameter of the superhydrophobic material, and the at least one passage extends through a length of the superhydrophobic filter from a first end to a second end, where the first end of the superhydrophobic filter is aligned with the inlet, wicking gas from the liquid-gas mixture between layers of the superhydrophobic filter to separate gas from liquid of the liquid-gas mixture in the at least one passage, directing gas out of a first outlet of the multiphase separator, the first outlet perpendicular to the inlet, and directing liquid out of a second outlet of the multiphase separator, the second outlet aligned with the second end, parallel to the inlet and perpendicular to the first outlet. In a first example of the method, the method further comprises: adjusting an amount of backpressure provided to the multiphase separator by a backpressure source coupled to the multiphase separator. In a second example of the method, optionally including the first example, the method further comprises: decreasing the amount of backpressure provided by the backpressure source when a volume of gas is directed out of the second outlet of the multiphase separator. In a third example of the method, optionally including one or both of the first and second examples, the method further comprises: directing the liquid-gas mixture through the at least one passage of the superhydrophobic filter configured as a helical passage and inducing centrifugal acceleration of the liquid-gas mixture to drive gas out of the liquid-gas mixture to outer walls of the helical passage and drive gas out of the superhydrophobic filter. In a fourth example of the method, optionally including one or more or each of the first through third examples, the method further comprises: driving liquid through the at least one passage from the first end to the second end of the superhydrophobic filter and preventing the liquid from being absorbed by outer walls of the at least one passage using properties of the superhydrophobic material. In a fifth example of the method, optionally including one or more or each of the first through fourth examples, the method further comprises: driving the liquid-gas mixture to impinge on outer walls of the at least one passage, the outer walls formed of the superhydrophobic material has a greater than 150-degree contact angle and driving gas into the superhydrophobic material.

FIGS. 1-7 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A multiphase separator, comprising:
an inlet;
a first outlet perpendicular to the inlet;
a second outlet in linear alignment with the inlet and perpendicular to the first outlet; and
a superhydrophobic filter formed of superhydrophobic material with at least one passage extending through a length of the superhydrophobic filter along a central axis extending from a first end to a second end, where the first end of the superhydrophobic filter is aligned with the inlet and the second end of the superhydrophobic filter is aligned with the second outlet, and a diameter of the passage is greater than an effective pore diameter of the superhydrophobic material.

2. The multiphase separator of claim 1, wherein the at least one passage has a helical configuration.

3. The multiphase separator of claim 1, wherein the at least one passage comprises three helical passages extending along the central axis from the first end to the second end of the superhydrophobic filter.

4. The multiphase separator of claim 1, wherein the at least one passage comprises at least one of overlapped helical passages, interwoven helical passages, right handed thread helical passages, or left handed thread helical passages.

5. The multiphase separator of claim 1, wherein the superhydrophobic material is configured as a plurality of layered planar superhydrophobic disks which are superhydrophobic on both a first face and a second face of a respective superhydrophobic disk.

6. The multiphase separator of claim 1, wherein the superhydrophobic filter has a same degree of superhydrophobicity throughout the superhydrophobic filter.

7. The multiphase separator of claim 1, wherein the superhydrophobic material is configured to absorb and/or retain and/or transport gas, but generally not liquid.

8. The multiphase separator of claim 1, further comprising a housing formed of a cap and a body, the cap removably coupled to the body via a plurality of bolts and a corresponding plurality of nuts, the body configured to have the superhydrophobic filter positioned therein.

9. The multiphase separator of claim 8, wherein a diameter of the superhydrophobic filter is less than an inner diameter of the housing of the multiphase separator, and a plenum is formed between the superhydrophobic filter and the housing.

10. The multiphase separator of claim 8, wherein the body includes the inlet and the first outlet and the cap includes the second outlet.

11. The multiphase separator of claim 8, wherein the superhydrophobic filter is in face sharing contact with the body of the housing at the first end.

12. A multiphase separation device, comprising:
a gas-wicking and liquid-rejecting corkscrew passage formed of a plurality of superhydrophobic disks stacked to form a superhydrophobic filter, wherein each superhydrophobic disk is superhydrophobic on both faces and creates a capillary seal between superhydrophobic disk layers when stacked.

13. The multiphase separation device of claim 12, further comprising a housing which annularly encloses the superhydrophobic filter and has an inlet on a first end, a first outlet perpendicular to the inlet and positioned at an approximate middle of a length of the housing, and a second outlet in linear alignment with the inlet.

14. The multiphase separation device of claim 13, wherein the superhydrophobic filter is removably positioned in the housing by a plurality of bolts.

15. A method for operating a multiphase system, comprising:
directing a liquid-gas mixture from a liquid-gas source into an inlet of a multiphase separator;
directing the liquid-gas mixture through at least one passage of a superhydrophobic filter of the multiphase separator, wherein the superhydrophobic filter is formed of layered planar superhydrophobic material, a diameter of the passage is greater than an effective pore diameter of the superhydrophobic material, and the at least one passage extends through a length of the superhydrophobic filter from a first end to a second end, where the first end of the superhydrophobic filter is aligned with the inlet;
wicking gas from the liquid-gas mixture between layers of the superhydrophobic filter to separate gas from liquid of the liquid-gas mixture in the at least one passage;
directing gas out of a first outlet of the multiphase separator, the first outlet perpendicular to the inlet; and
directing liquid out of a second outlet of the multiphase separator, the second outlet aligned with the second end, parallel to the inlet and perpendicular to the first outlet.

16. The method of claim 15, further comprising adjusting an amount of backpressure provided to the multiphase separator by a backpressure source coupled to the multiphase separator.

17. The method of claim 16, further comprising decreasing the amount of backpressure provided by the backpressure source when a volume of gas is directed out of the second outlet of the multiphase separator.

18. The method of claim 15, further comprising directing the liquid-gas mixture through the at least one passage of the superhydrophobic filter configured as a helical passage and inducing centrifugal acceleration of the liquid-gas mixture to drive gas out of the liquid-gas mixture to outer walls of the helical passage and drive gas out of the superhydrophobic filter.

19. The method of claim 15, further comprising driving liquid through the at least one passage from the first end to the second end of the superhydrophobic filter and preventing the liquid from being absorbed by outer walls of the at least one passage using properties of the superhydrophobic material.

20. The method of claim 15, further comprising driving the liquid-gas mixture to impinge on outer walls of the at least one passage, the outer walls formed of the superhydrophobic material has a greater than 150-degree contact angle and driving gas into the superhydrophobic material.
